(19) United States
(12) Patent Application Publication
(10) Pub. No.: US 2006/0185534 A1
(43) Pub. Date: Aug. 24, 2006

(54) Stencil printer

(75) Inventor: Kazuyoshi Kobayashi, Miyagi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Tohoku Ricoh Co., Ltd., Shibata-gun (JP)

(21) Appl. No.: 11/342,537

(22) Filed: Jan. 31, 2006

(30) Foreign Application Priority Data
Feb. 15, 2005 (JP) 2005-37754(JP)

(51) Int. Cl. B41L 13/00

(52) U.S. Cl. 101/120

(57) ABSTRACT

A stencil printer of the present invention includes a print drum, an ink feeding device for feeding ink to the inside periphery of the print drum, an ink replenishing device for replenishing ink to the ink feeding device, and a controller configured to control, based on print conditions, replenishment of the ink to the ink feeding device effected by the ink replenishing device. The stencil printer with this configuration is capable of continuously operating even when the ink stored therein is degenerated.

### BACKGROUND OF THE INVENTION

1. Field of the Invention

The present invention relates to a stencil printer and more particularly to control over ink replenishing means included in a stencil printer for replenishing fresh ink to an ink well formed in a print drum.

2. Description of the Background Art

A digital, thermosensitive stencil printer is extensively used as a simple, convenient printer and loaded with a stencil made up of a thermoplastic resin film and a porous support adhered together. The stencil printer includes a thermal head having a number of heat generating elements arranged thereon and conveying means, including a platen roller, for conveying the stencil held in contact with the thermal head. The heat generating elements of the thermal head are selectively energized by pulse current in order to selectively perforate, or cut, the thermoplastic resin film of the stencil with heat in accordance with image data. The perforated part of the stencil, i.e., a master is cut off and then wrapped round a porous, hollow print drum. Subsequently, a paper sheet or similar recording medium is pressed against the outer periphery of the print drum with the result that ink is transferred to the paper sheet via the porous portion of the print drum and the perforations of the master, forming an image on the paper sheet.

It is a common practice with the stencil printer to arrange an ink roller and a doctor roller in the vicinity of the inner periphery of the print drum such that the rollers are feely rotatable while adjoining each other. Ink is fed to a position where the ink roller and doctor roller adjoin each other so as to form an ink well. The ink is fed from the ink well to the ink roller to form an ink layer having preselected thickness via a small gap between the ink roller and the doctor roller. In this condition, when the pressing means presses the print drum via the paper sheet and master, the ink is transferred from the ink roller to the inner periphery of the print drum.

The ink applicable to the stencil printer is generally implemented as water-in-oil type of emulsion ink in which a great amount of water is dispersed in oil in addition to a pigment, so that the ink does not easily dry in an inoperative condition, but smoothly penetrates the surface of a paper sheet and rapidly dries in an operative condition. Such emulsion ink is fed under pressure from a cartridge disposed in the print drum or the casing of the printer to the ink well by a pump or similar ink replenishing means. A controller controllably drives the ink replenishing means in accordance with the output of sensing means responsive to the level of the inkwell or the capacitance of the ink. A stencil printer including this type of ink replenishing means is disclosed in, e.g., Japanese Patent Laid-Open Publication No. 2000-218918.

Although degeneration ascribable to the evaporation of water occurs in the emulsion type of ink little, part of the ink left unused during printing is kneaded in such a manner as to be stretched on the inner periphery of the print drum because of the arrangement of the ink roller, doctor roller and ink well, which constitute ink feeding means, with the result that the emulsion structure of the ink is destroyed little by little. When such kneading continues over a long period of time, the ink is degenerated due to evaporation of water and has its capacitance varied and its viscosity lowered. A long time of kneading occurs when the amount of ink to be transferred from the ink drum to a single paper is small, e.g., when a great number of prints are continuously produced at high speed or with a document whose image area is extremely small or at low environmental temperature.

If the capacitance of the ink is varied due to the print condition mentioned above, the ink is erroneously determined to be short despite that a sufficient amount of ink is left in the ink well. Consequently, it is likely that fresh ink is replenished to the ink well in such an amount that it overflows the ink well and smears the inside of the printer. Also, it is likely that when the ink left unused on the ink roller is again collected in the ink well, the balance between collection and feed is disturbed with the result that the ink forms a thicker film than usual on the inner periphery of the print drum and leaks via the ends of the print drum and smears the inside of the printer.

### SUMMARY OF THE INVENTION

It is an object of the present invention to provide a stencil printer capable of continuously operating even when ink stored therein is degenerated.

A stencil printer of the present invention includes a print drum, an ink feeding device for feeding ink to the inside periphery of the print drum, an ink replenishing device for replenishing ink to the ink feeding device, and a controller for controlling, based on a print condition, replenishment of the ink to the ink feeding device effected by the ink replenishing device.

Also, a stencil printer of the present invention includes a print drum, an ink roller for feeding ink to the inner periphery of the print drum, a doctor roller for feeding a preselected amount of ink to the outer periphery of the ink roller, an ink sensor for sensing the amount of ink present in an ink well formed between the ink roller and the doctor roller, and an ink replenishing device for replenishing ink to the ink well in accordance with the output of the ink sensing device. When a sense replenishment interval determined in accordance with the output of the ink sensor varies by more than a preselected amount inclusive due to repeated printing, a controller controls the ink replenishing device such that the ink replenishing device replenishes ink at the initial sense replenishment interval.

### BRIEF DESCRIPTION OF THE DRAWINGS

The above and other objects, features and advantages of the present invention will become more apparent from the following detailed description taken with the accompanying drawings in which:

FIG. 1 is a front view showing a stencil printer to which a first to a fourth embodiment of the present invention are applied;

FIG. 2 is a plan view showing a sheet tray and sheet size sensing means included in each of the first to fourth embodiments;

FIG. 3 is a view showing an ink pump and ink well formed in ink feeding means also included in each of the first to fourth embodiments;

FIG. 4 is a block diagram schematically showing a control system further included in each of the first to fourth embodiments;

FIG. 5 is a table showing a relation between print speeds, temperatures and ink consumption coefficients;

FIG. 6 is a timing chart demonstrating control over the ink pump executed in the second and third embodiments; and

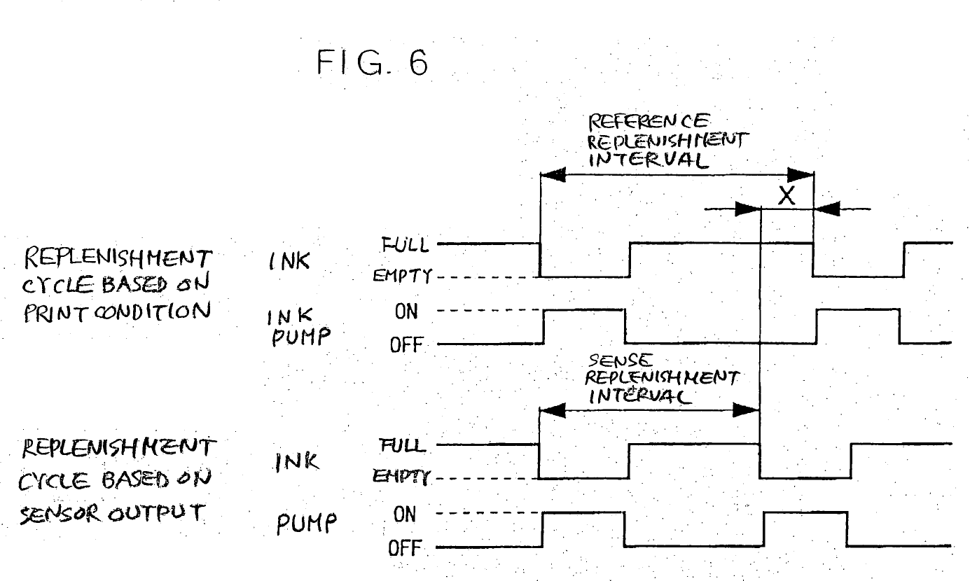

FIG. 7 is a timing chart for describing another alternative embodiment of the present invention.

### DESCRIPTION OF THE PREFERRED EMBODIMENTS

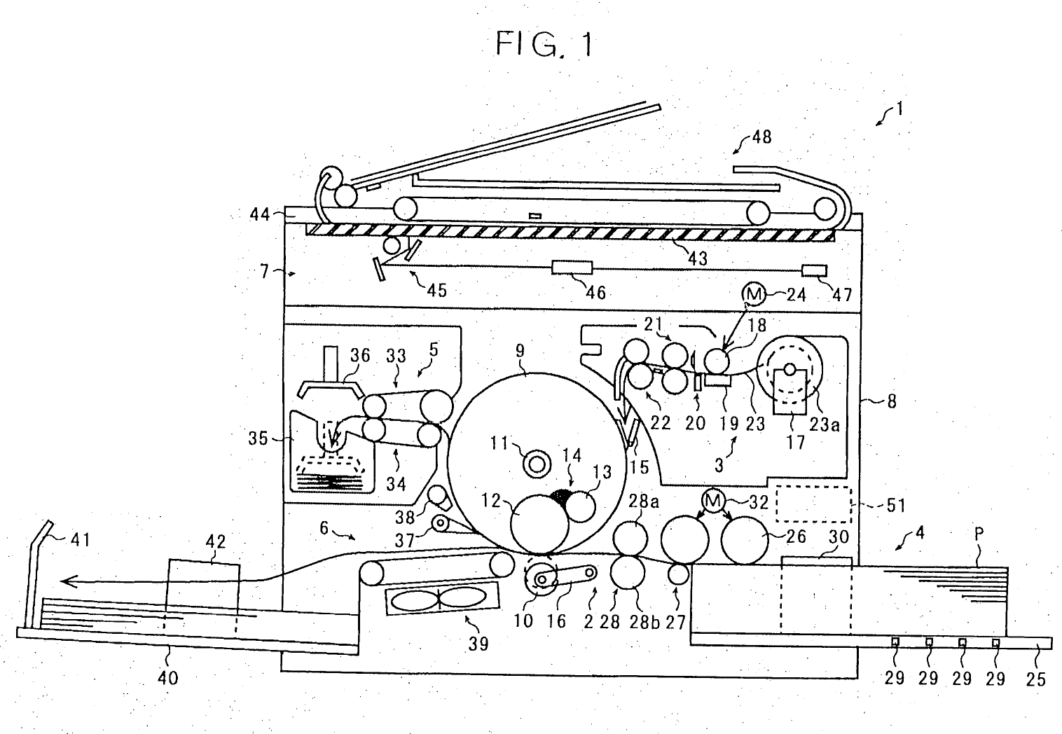

Referring to FIG. 1 of the drawings, a stencil printer to which a first embodiment of the present invention is applied is shown and generally designated by the reference numeral 1. As shown, the stencil printer 1 includes a printing section 2, a master making section 3, a sheet feeding section 4, a master discharging section 5, a sheet discharging section 6 and an image reading section 7. These sections 1 through 7 are disposed in a printer body or casing 8.

The printing section 2, arranged at substantially the center of the printer body 8, includes a print drum 9 and a press roller 10. The print drum 9 is rotatably mounted on a shaft 11 that plays the role of an ink feed pipe at the same time. The print drum 9 is driven by drum drive means, not shown, and removable from the printer body 8. Ink feeding means 14 is disposed in the ink drum 9 and includes an ink roller 12 and a doctor roller or doctor member 13. A clamper 15 is mounted on the outer periphery of the print drum 9 in such a manner as to be openable for clamping the leading edge of a master, which will be described specifically later. The doctor roller 13 may be replaced with a flat doctor member, if desired.

The press roller 10 is positioned below the print drum 9 and has a shaft rotatably supported by a pair of arm members (only one is visible) 16 at opposite ends thereof. When the arm members 16 are caused to angularly move by arm drive means, not shown, they selectively move the press roller 10 to a spaced position where the press roller 10 is released from the print drum 9 or a contact position where the former is pressed against the latter. The spaced position and contact position are indicated by a solid line and a phantom line in FIG. 1, respectively.

The master making section 8, located in the top right portion of the casing 8, includes a stencil holding member 17, a platen roller 18, a thermal head 19, master cutting means 20 and roller pairs 21 and 22 for conveying a stencil. In the illustrative embodiment, a stencil 23 is paid out from a stencil roll 23a supported by the stencil holding member 17. More specifically, the stencil 23 is made up of a thermoplastic resin film and a porous support adhered together and includes a core rotatably, removably supported by the stencil holding member 17.

The platen roller 18 is rotatably supported by opposite side walls, not shown, included in the printer body 8 at the left-hand side of the stencil holding member 17, as viewed in FIG. 1, and is driven by a stepping motor 24. The thermal head 19, also supported by the side walls of the printer body 8, includes a number of heat generating elements arranged on one major surface thereof and has the major surface pressed against the platen roller 18 by biasing means not shown. The heat generating elements of the thermal head 19 are selectively energized in contact with the thermoplastic resin film surface of the stencil 23 to thereby perforate, or cut, the stencil 23 with heat in accordance with image date.

The master cutting means 20 is located at the left-hand side of the platen roller 18 and thermal head 19, as viewed in FIG. 1. The master cutting means 20 includes a stationary edge affixed to a frame member, not shown, included in the printer body 8 and a movable edge movably supported toward or away from the stationary edge in the angular direction or the up-and-down direction. The movable edge cuts off the perforated part of the stencil 23 when moved toward the stationary edge, thereby producing a master.

The roller pairs 21 and 22, positioned at the left-hand side of the master cutting means 20 in FIG. 1, each are made up of a drive roller and a driven roller rotably supported by the side walls of the printer body 8. Each drive roller is driven in synchronism with the platen roller 18 in the same direction by drive means, not shown, while each driven roller is pressed against the associated drive roller by respective biasing means not shown.

The sheet feeding section 4, positioned below the master masking section 3, includes a sheet tray 25, a pickup roller 26, a separation roller pair 27 and a registration roller pair 28. The sheet tray 25 is loaded with a stack of paper sheets or similar recording media P and supported by the printer body 8 in such a manner as to be freely movable in the up-and-down direction. Elevating means, not shown, causes the sheet tray 25 to move in the above direction.

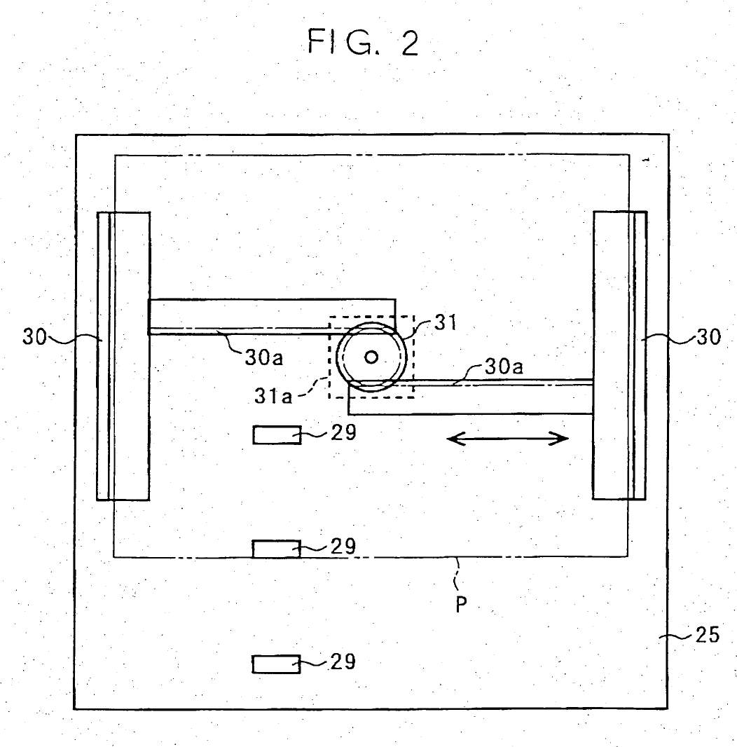

A plurality of sensors or sheet size sensing means 29 are disposed in the sheet tray 25, which is implemented as a box, and so positioned as to sense the size of the paper sheets P. A pair of side fences 30 are mounted on the top of the sheet tray 25. As shown in FIG. 2 specifically, each side fence 30 is provided with a rack portion 30a while a pinion 31 is mounted on the sheet tray 25 and held in mesh with the rack portion 30a. An encoder type sensor or another sheet size sensing means 31a is connected to the pinion 31. The side fences 30 with such a configuration are movable toward and away from each other in synchronism in the direction of sheet width perpendicular to the direction of sheet conveyance. The sensors 29 and sensor 31a sense the sizes of the sheets P stacked on the sheet tray 25 in the direction of conveyance and the direction of width, respectively.

Referring again to FIG. 1, the pickup roller 26 is positioned at the upper left of the sheet tray 25 and covered with a high-friction resistance member. The pickup roller 26 is rotatably supported by a bracket, not shown, angularly movably supported by the printer body 8 such that when the sheet tray 25 is raised by the elevating means, the top sheet P on the sheet tray 25 is pressed against the pickup roller 26. The pickup roller 26 is caused to rotate by a sheet feed motor 32, which is implemented by a stepping motor.

The separation roller pair 27, positioned at the left-hand side of the pickup roller 26, is made up of an upper and a lower roller covered with a high-friction resistance member each. The upper roller is rotated by the sheet feed motor 32 in synchronism with the pickup roller 26 in the same direction. The lower roller is constantly pressed against the upper roller by biasing means, not shown, and configured to rotate only in the same direction as the upper roller.

The registration roller pair 28, positioned at the left-hand side of the separation roller pair 27, is made up of a drive roller 28a and a driven roller 28b. The drive roller 28a is rotatably supported by the side walls of the printer body 8 and caused to rotate in synchronism with the print drum 9 by drum drive means, not shown, via drive transmitting means not shown. The driven roller 28b, also rotatably supported by the above side walls, is constantly pressed against the drive roller 28a by biasing means not shown.

The master discharging section 5, arranged at the upper left of the printing section 2, includes an upper discharge member 33, a lower discharge member 34, a discharge box 35 and a pressing plate 36. The upper and lower discharge members 33 and 34 include a respective drive roller, a driven roller and an endless belt each. When discharge drive means, not shown, causes the drive roller to rotate, the endless belt is turned in a preselected direction. Moving means, not shown, causes the lower discharge member 34 to selectively move between the initial position shown in FIG. 1 and a peel position where the endless belt contacts the circumferential surface of the print drum 9.

The discharge box 35, included in the master discharge section 5, is removably mounted to the casing 8 while the pressing plate 36 is movable up and down by being driven by elevating means not shown. When the upper and lower discharge member 33 and 34 cooperate to convey a used master to a position above the discharge box 35, the pressing member 36 is lowered to press the used master into the discharge box 35.

The sheet discharging section 6, positioned below the master discharging section 5, includes a peeler 37, a peel fan 38, sheet conveying means 39 and a print tray 40. The peeler 37 is angularly movably supported by the printer body 8 at one end thereof. Peeler moving means, not shown, causes the peeler 37 to move between a close position where the other end or sharp free end of the peeler 37 is positioned close to the periphery of the print drum 9 and a remote position where the former is spaced from the latter so as not to interfere with the damper 15 and other obstacles. The peel fan 37, positioned above the peeler 37, blows air toward the free end of the peeler 37 in order to help the peeler 37 peel off the paper sheet P adhering to the print drum 9.

The sheet conveying means 39, positioned at the lower left of the peeler 37, includes a drive roller, a driven roller, an endless belt and a suction fan. When the drive roller is caused to rotate by sheet discharge drive means, not shown, the endless belt conveys the paper sheet or print P retained on the endless belt by the suction fan toward the print tray 40.

Prints P, sequentially driven out of the casing 8 by the sheet discharging means 39 are stacked on the print tray 40, which is positioned at the left-hand side of the sheet conveying means 39. A single end fence 41 and a pair of side fences 42 are mounted on the print tray 40. The end fence 41 is movable in the direction of sheet conveyance while the side fences 42 are movable toward and away from each other in the widthwise direction of the print P perpendicular to the direction of sheet conveyance.

The image reading section 7, arranged in the upper portion of the casing 8, includes a glass platen 43 on which a document is to be laid, a cover plate 44 movable toward and away from the glass platen 43, a scanner unit 45 for scanning the document laid on the glass platen 43, a lens 46 for focusing an optical image of the document output from the scanner unit 45, and a CCD (Charge Coupled Device) image sensor or similar image sensor 47 on which the optical image is focused by the lens 46. An ADF 48 is mounted on the cover plate 44 and used when a plurality of documents should be automatically, sequentially read.

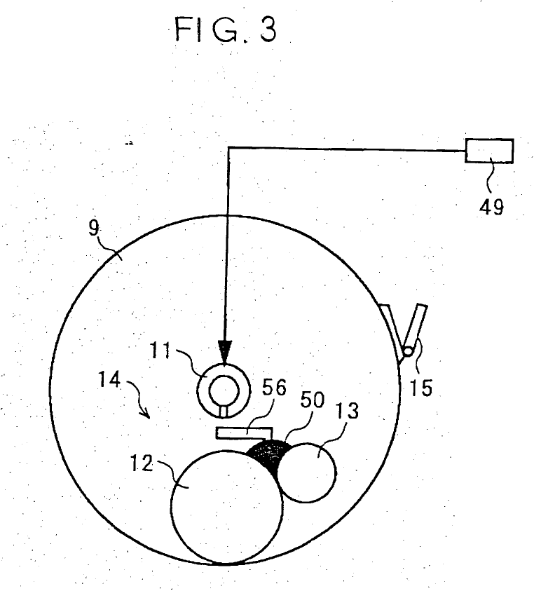

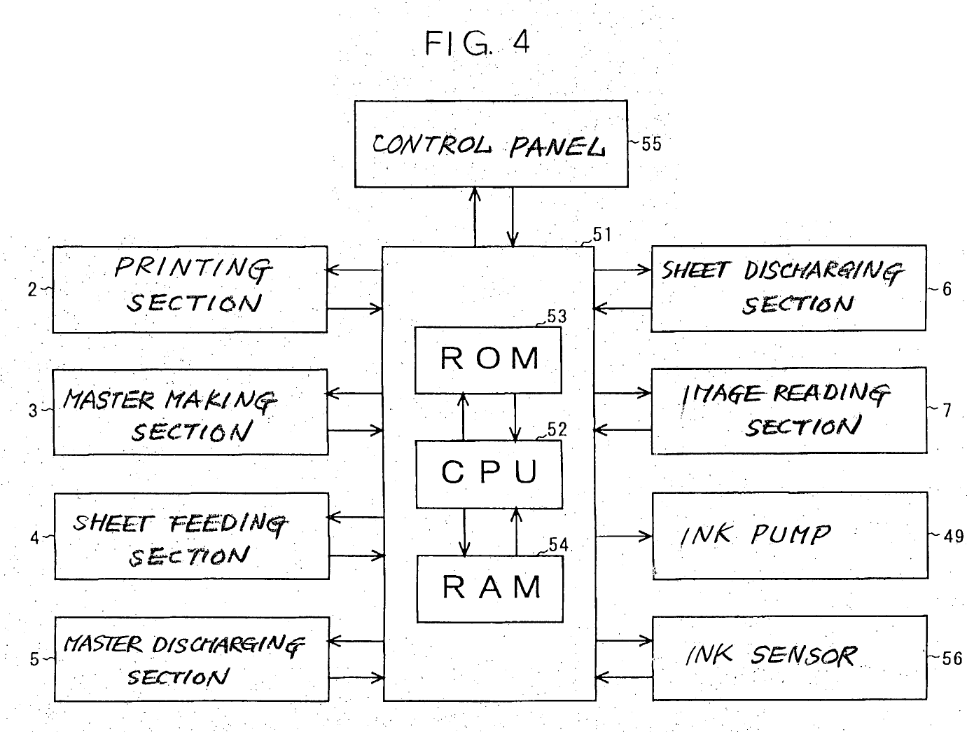

FIG. 3 shows ink replenishing means disposed in the printer body 8 and implemented as an ink pump 49. As shown, the ink pump 49 is positioned between an ink pack, not shown, and the shaft 11 and configured to deliver ink under pressure from the ink pack to the shaft 11. The ink is then fed to a position where the ink roller 12 and doctor roller 13 adjoin each other via the shaft 11 and an ink feed pipe, not shown, forming an ink well 50. The ink in the ink well 50 is fed to the ink roller 12 via a small gap between the ink roller 12 and the doctor roller 13, forming an ink layer on the ink roller 12. When the press roller 10 is brought to the contact position and pressed against the print drum 9, the ink on the ink roller 12 is fed to the inner periphery of the print drum 9. A controller or control means 51, see FIG. 4, controls the operation of the ink pump 49, as will be described in detail later.

As also shown in FIG. 3, the ink feeding means 14 includes an ink sensor or ink sensing means 56 responsive to the amount of ink. When the ink replenished from the ink pack by the ink pump 49 reaches a preselected amount in the ink well 50, the ink sensor 56 sends a signal to the controller 51.

FIG. 4 schematically shows a control system included in the stencil printer 1. As shown, the control system includes the controller 51 implemented as a conventional microcomputer including a CPU (Central Processing Unit) 52, a ROM (Read Only Memory) and a RAM (Random Access Memory) 54. The controller 51 receives various signals including an operation signal output from a control panel 55, which is mounted on the top front of the printer body 8, and signals output from the ink sensor 56 and other various sensors, as illustrated. The controller 51 controls the operations of the printing section 2, master making section 3, sheet feeding section 4, master discharging section 6, image reading section 7 and ink pump 49 in response to the various signals mentioned above.

More specifically, the output signals of the sensors and control panel 55 are input to the CPU 42. In response, the CPU 42 executes operations with the input signals in accordance with operation programs stored in the ROM 43 and sends the resulting signals to drivers, which are assigned to the printing section 2, master masking section 3, sheet feeding section 4, master discharging section 6, image reading section 7 and ink pump 49, as operation signals while sending a display signal to the control panel 55.

The control programs stored in the ROM 43 each are used to operate a particular actuator included in the stencil printer 1. Particularly, the operation of the ink pump 49 is controlled in accordance with print conditions input on the control panel 55.

Any one of the operation programs called from the ROM 53 is written to the RAM 54 for a moment and updated by a signal fed from the control panel 55. Also written to the RAM 54 are the amounts of ink to be used in one-to-one correspondence to preselected print conditions. In the illustrative embodiment, the preselected print conditions consist of a print speed, the number of prints to be output, environmental temperature including room temperature, temperature inside the print drum 9 and ink temperature, and an amount of an image. The amounts of ink to be used are determined by experiments beforehand in the various print conditions. Environmental temperature is measured by a thermometer, not shown, while the amount of an image is measured at the time of document reading or at the time of prescanning preceding it.

The operation of the stencil printer 1 having the above construction will be described hereinafter. First, the operator of the stencil printer 1 lays a desired document on the glass platen 43, closes the cover plate 44 and then presses a perforation start key, not shown, positioned on the control panel 55. In response, in the image reading section 7, the scanner unit 45 scans the document to output an optical image representative of the document while the lens 46 focuses the optical image on the image sensor 47.

In parallel with the above image reading operation, the master discharging section 5 peels off a used master adhering to the outer periphery of the print drum 9. More specifically, when the perforation start key is pressed, the print drum 9 is caused to start rotating and then stop rotating at a preselected master discharge position. Subsequently, the lower discharge member 34 is driven and moved to the peel position so as to turn up the used master on the print drum 9. Then, the print drum 9 is again driven while the upper discharge member 33 is caused to start operating. As a result, the used master is conveyed by the upper and lower discharge members 33 and 34 to the discharge box 35 and then compressed in the box 35 by the pressing plate 36. At the same time, the print drum 9 is rotated to a preselected master feed position and then stopped there. At the master feed position, the clamper 15 is angularly moved away from the print drum 9 to wait for a master. The stencil printer 1 remains in such a stand-by condition thereafter.

In the stand-by condition, the platen roller 18 and roller pairs 21 and 22 are driven to pull out the stencil 23 from the stencil roll 23a. While the stencil 23a thus paid out is being conveyed via the thermal head 19, the thermal head 19 perforates, or cuts, the stencil 23 with heat for thereby form an image in the thermoplastic resin film of the stencil 23. The stencil 23 is then further conveyed toward the damper 15 while being continuously perforated by the thermal head 19. As soon as the controller 51 determines, in terms of the number of steps of the stepping motor 24, that the leading edge of the stencil 23, as seen in the direction of conveyance, has reached a position where it can be clamped by the damper 15, the damper 15 is closed to retain the leading edge of the stencil 23 on the outer periphery of the print drum 9.

Subsequently, the print drum 9 is rotated at a peripheral speed corresponding to the conveyance speed of the stencil 23, causing the perforated part of the stencil 23, i.e., a master to be wrapped round the print drum 9. As soon as a single master, also designated by the reference numeral 23, is fully perforated, the platen roller 13 and roller pairs 21 and 22 are caused to stop rotating while the master cutting means is driven to cut off the master 23. The master 23 thus cut off is pulled out of the master making section 3 by the print drum 9 in rotation. When the print drum 9 is rotated to its home position and stopped there, the master making and feeding operation is completed.

The master feeding operation is followed by a master adhering operation to be described hereinafter. When the print drum 9 is stopped at the home position, the sheet feeding section 4 is driven to pay out the top sheet P from the sheet tray 25 toward the registration roller pair 28. The registration roller pair 28 stops the paper sheet P in order to correct skew thereof. At the same time, the print drum 9 is caused to rotate clockwise, as viewed in FIG. 1, at low speed. Subsequently, the drive roller 28a of the registration roller pair 28 is caused to start rotating at the time when the leading edge of the image portion of the master 23 in the direction of rotation of the print drum 9 is brought to a position where it is expected to contact the press roller 10, conveying the paper sheet P to a gap between the print drum 9 and the press roller 10.

At substantially the same time as the drive roller 28a starts rotating, the moving means, not shown, causes the press roller 10 to angularly move into pressing contact with the outer periphery of the print drum 9, so that the paper sheet P is pressed against the master 23 present on the print drum 9. Consequently, the press roller 10, paper sheet P, master 23 and print drum 9 are pressed against each other, causing the ink deposited on the inner periphery of the print drum 9 by the ink roller 12 to be filled in the porous support of the master 23 via the porous portion of the print drum 9. Thereafter, the ink is transferred to the paper sheet P via the perforations of the master 23, thereby causing the master 23 to adhere to the outer periphery of the print drum 9.

The paper sheet to which an image has been transferred by the above adhering operation is peeled off from the print drum 9 by the peeler 37 and peel fan 38 and then dropped onto the sheet conveying means 39. The sheet conveying means 39 conveys the paper sheet or print P to the print tray 40. Thereafter, the print drum 9 is again rotated to the home position and then stopped there, ending the master adhering operation. In this condition, the stencil printer 1 remains in a stand-by position.

Subsequently, the operator inputs a desired print speed on the control panel 55 and then presses a trial print key, not shown, also positioned on the control panel 55. In response, the print drum 9 is driven at a peripheral speed matching with the desired print speed while a single paper sheet P is fed from the sheet feeding section 4, so that an image is formed on the paper sheet P in the same manner as during master adhering operation. If the position and/or the density of the image printed on the paper sheet P by trail printing is acceptable, then the operator inputs a desired number of prints on the control panel 55 and then presses a print start key, not shown, also positioned on the control panel 55. When the desired number of prints P are fully produced, the print drum 9 is brought to a stop at the home position. In this condition, the stencil printer 1 again remains in the stand-by position.

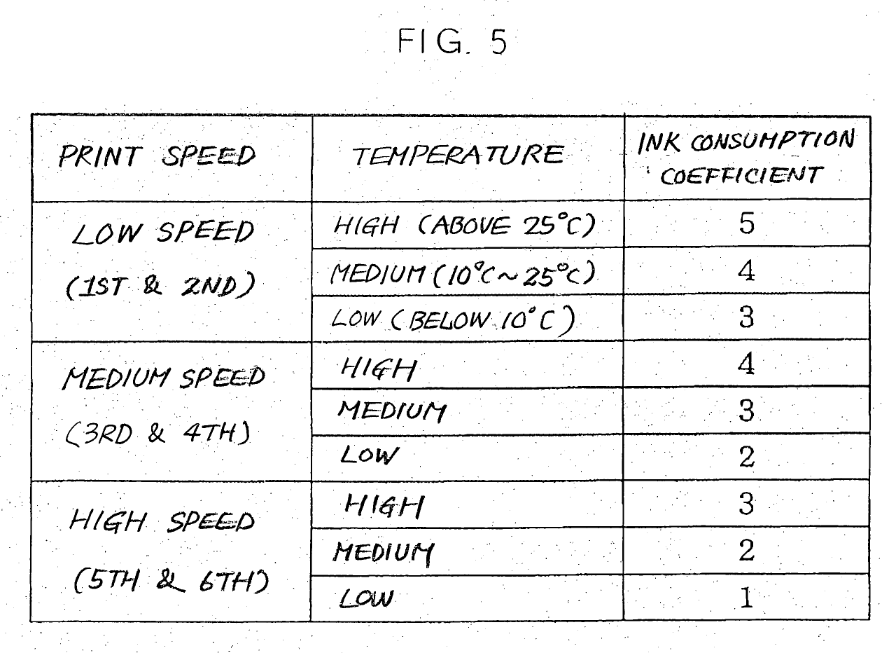

The ink replenished by the ink pump 49 to the ink well 50 during the printing operation described above is consumed in an amount dependent on the print conditions. The illustrative embodiment is configured to calculate an ink consumption coefficient on the basis of, among the various print conditions mentioned previously, i.e., the number of prints, print speed, environmental temperature and the amount of an image, the combination of the print speed and environmental temperature and multiplies the coefficient thus calculated by the amount of an image, thereby producing an amount of ink to be consumed. The amount of an image refers to the ratio of a solid image portion to the entire image. FIG. 5 is a table listing various ink consumption coefficients assigned to the stencil printer 1.

In the above construction, assume that the ink well 50 has a capacity of “100” and that the amount of ink to be replenished by one time of drive of the ink pump 49 is “20”. Then, when the ink pump 49 is driven five consecutive times in the condition wherein the ink well 50 is empty, the ink is stored in the ink well 50 in a preselected amount with the result that the ink sensor 56 sends a signal to the controller 51. In response, the controller 51 determines that the ink well 49 is full.

Further, assume that the amount of ink to be consumed is “40” when printing is executed from the full condition of the ink well 49 under print conditions including, e.g., an amount of image of 1%, a third print speed, environmental temperature of 20° C. and a desired number of prints is one hundred, as determined by experiments. Then, the ink pump 49 is driven one time when fifty prints are produced. When the amount of image is 2%, the ink pump 49 is driven one time when twenty-five prints are produced.

On the other hand, under the print conditions including an amount of image of 1%, a second print speed, environmental temperature of 20° C. and a desired number of prints is one hundred, the ink consumption coefficient is 4/3 times greater than under the conditions stated above, so that the ink pump 49 is driven one time when 37.5 prints are produced. If the print speed is increased to a fifth print speed with the other conditions being maintained the same, then the amount of ink to be consumed becomes 2/3 times, so that the ink pump 49 is driven one time when seventy-five prints are produced.

With the above configuration, the illustrative embodiment allows the controller 51 to calculate an amount of ink to be consumed on the basis of the print conditions, i.e., without relying on the output of the ink sensor 56 and then control the ink pump 49 in matching relation to the amount of ink to be consumed calculated. It follows that even when the ink is kneaded over a long time and degenerated thereby, the fresh ink replenished from the ink pump 49 is prevented from overflowing the ink well 50 and smearing the inside of the stencil printer 1.

In the illustrative embodiment, it is assumed that the capacity of the ink well 50 is “100”, that the amount of ink replenished by one time of drive of the ink pump 49 is “20”, and that the ink pump 49 is driven by the controller 51 when “20” ink, corresponding to one time of drive of the ink pump 49, is consumed. Alternatively, an arrangement may be made such that when the ink is consumed in the amount of “40” corresponding to two times of drive of the ink pump 49, the amount of “60” corresponding to three times of drive of the ink pump 49, the amount of “80” corresponding to four times of drive of the ink pump 49 and the amount of “100” corresponding to the substantially empty condition of the inkwell 50, the controller 50 drives the ink pump 49 a particular number of times corresponding to each of the above amounts of consumption.

A second embodiment of the present invention will be described hereinafter. The second embodiment is identical with the first embodiment except for the control to be executed by the controller 51. Briefly, in the illustrative embodiment, the ink pump 49 is controllably driven on the basis of both of the output of the ink sensor 56 and the amount of ink to be consumed calculated by the controller 51.

More specifically, in the illustrative embodiment, the controller 51 not only calculates an amount of ink to be consumed on the basis of print conditions, but also controls the drive of the ink ump 49 in accordance with the signal output from the ink sensor 56. So long as the ink in the ink well 50 is degenerated little because it has just been replenished by the ink pump 49, the output of the ink sensor 56 is free from errors. In this condition, the controller 51 drives the ink pump 49 for replenishing the ink to the ink well 50 only when the output of the ink sensor 56 is representative of shortage. At this instant, the controller 51 is calculating an amount of ink to be consumed in accordance with the print conditions.

When the ink is degenerated little by little with the elapse of time, a difference occurs between the output of the ink sensor 56 representative of shortage and the amount of ink to be consumed calculated in accordance with the print conditions. For example, in the case where the controller 51 is expected to drive the ink pump 49 one time for fifty prints, the ink sensor 56 is apt to send a signal to the controller 51 at a time earlier than a calculated time due to the degeneration of the ink, causing the controller 51 to drive the ink pump 49. FIG. 5 demonstrates a specific case in which the above error occurs.

In FIG. 5, the upper part shows an ink replenishing cycle based on the print conditions; the controller 51 is expected to drive the ink pump 49 one time for fifty prints. In such an ink replenishing cycle, let the interval between the consecutive drives of the ink pump 49 be regarded as a reference replenishment interval. FIG. 5 shows in the lower part an ink replenishing cycle based on the output of the ink sensor 56; the controller 51 is shown as driving the ink pump 49 before fifty prints are produced. Such an interval will be referred to as a sense replenishment interval hereinafter.

At the initial stage of printing, a difference X between the reference replenishment interval and the sense replenishment interval is approximately zero because the ink is degenerated little. However, as the ink is degenerated little by little with the elapse of time, the difference X increases. In the illustrative embodiment, the controller 51 starts driving the ink pump 49 at the sense replenishment interval just after the start of printing and, when the difference X exceeds preselected one, the controller 51 drives the ink pump 49 at the reference replenishment interval. More specifically, in the illustrative embodiment, when the difference X exceeds 30% of the reference replenishment interval corresponding to fifty prints, i.e., when the difference X is greater than sixteen prints inclusive, the controller 51 replaces the sense replenishment interval with the reference replenishment interval.

As stated above, in the illustrative embodiment, the controller 51 calculates an amount of ink to be consumed on the basis of the print conditions and then controls the ink pump 49 with either one of the reference replenishment interval and sense replenishment interval. With such unique control, the illustrative embodiment prevents the ink replenished from the ink pump 49 from overflowing the ink well 50 and smearing the inside of the stencil printer 1 even when the ink is kneaded over a long time and degenerated thereby.

A third embodiment of the present invention will be described hereinafter. The third embodiment is generally identical with the second embodiment except for the following. In the third embodiment, the controller 51 controls the operation of the ink pump 49 at the reference replenishment intervals for a preselected period of time after the difference X has exceeded the pre-selected one, and then controls it in accordance with the output of the ink sensor 56. Subsequently, when the difference X between the sense replenishment interval up to the drive of the ink pump 49 and the reference replenishment interval lies in the above preselected range, the controller 51 controls the ink pump 49 at the sense replenishment interval by determining that the ratio of degenerated ink in the ink well 50 has decreased due to replenishment of fresh ink.

As stated above, in the first embodiment, the controller 51 calculates an amount of ink to be consumed on the basis of the print conditions and then controls the operation of the ink pump 49 at the reference replenishment intervals based on the amount of ink thus calculated. In the second embodiment, the controller 51 drives the ink pump 49 at the sense replenishment intervals based on the output of the ink sensor 56 at the initial stage of printing and then drives the ink pump 49 at the reference replenishment intervals when the difference between the sense replenishment interval and the reference replenishment interval exceeds a preselected amount due to the degeneration of the ink ascribable to repeated printing.

The third embodiment differs from the above two embodiments in that the controller 51 controls the drive of the ink pump 49 at the reference replenishment intervals for a preselected period of time and then controls it at the sense replenishment intervals, so that a cumulative error occurred in the reference replenishment intervals is absorbed during the control using the sense replenishment intervals. This more surely prevents the ink replenished from the ink pump 49 from overflowing the ink well 50 and smearing the inside of the stencil printer 1.

A fourth embodiment of the present invention will be described hereinafter. The fourth embodiment is identical with the first embodiment except for the control to be executed by the controller 51. Briefly, in the fourth embodiment, the controller 51 controls the drive of the ink pump 49 by using only the output of the ink sensor 56.

More specifically, in the illustrative embodiment, because the ink in the ink well 50 is degenerated little at the initial stage of printing, the controller 51 drives the ink pump 49 only when the output of the ink sensor 56 is representative of shortage, thereby replenishing the ink to the ink well 50. At this instant, the controller 51 writes the interval for driving the ink pump 49, i.e., sense replenishment interval in the RAM 54.

When the ink in the ink well 50 is degenerated little by little due to repeated printing, the sense replenishment interval decreases little by little with the result that the interval between the consecutive drives of the ink pump 49 by the controller 51 becomes short. In the illustrative embodiment, when the sense replenishment interval exceeds 30%, corresponding to sixteen prints, of the initial sense replenishment interval corresponding to fifty prints, the controller 51 calls the sense replenishment interval stored in the RAM and drives the ink pump 49 at such an interval.

In the above configuration, the controller 51 corrects the sense replenishment interval based on the output of the ink sensor 56. This is also successful to prevent the ink replenished from the ink pump 49 from overflowing the ink well 50 and smearing the inside of the stencil printer 1 even when the ink is degenerated due to a long time of kneading.

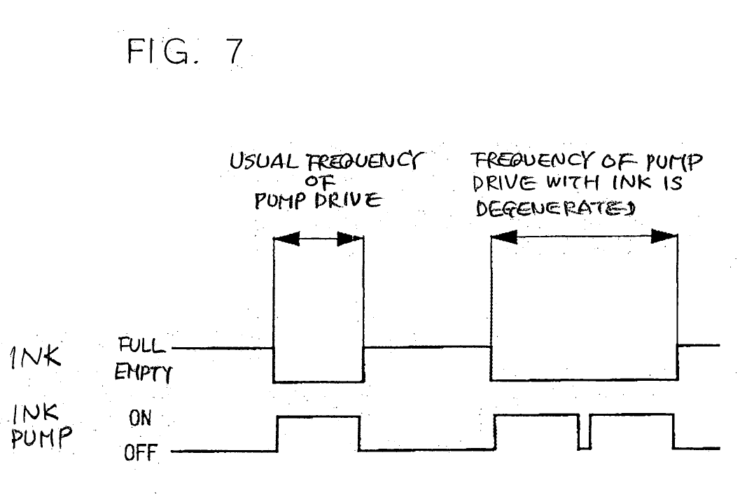

While the illustrative embodiments shown and described all cause the controller 51 to control the operation interval of the ink pump 49, the controller 51 may alternatively control the number of times of drive of the ink pump 49 while maintaining the interval between the drives constant, as shown in FIG. 7 specifically. Further, the controller 51 may control an interval between the time when the ink sensor 56 determines that the ink is short and the time when the ink is actually replenished in an adequate amount.

In summary, it will be seen that the present invention provides a stencil printer having the following various unprecedented advantages. A controller or control means controls ink replenishing means at reference replenishment intervals for a preselected period of time and then controls it in matching relation to a calculated amount of ink to be consumed. It is therefore possible to prevent ink replenished from the ink replenishing means from overflowing a print drum and smearing the inside of the stencil printer.

Further, the controller controls the operation of the ink replenishing means at reference replenishment intervals for a preselected period of time and then controls it at sense replenishment intervals, so that a cumulative error occurred in the reference replenishment intervals is absorbed during the control using the sense replenishment interval. It follows that the ink replenished from the ink replenishing means is prevented from overflowing ink feeding means and smearing the inside of the stencil printer.

Moreover, the controller corrects the sense replenishment interval based on the output of ink sensing means Therefore, even when the ink replenished from the ink replenishing means is degenerated due to a long time of kneading, it is prevented from overflowing the ink feeding means and smearing the inside of the stencil printer.

Various modifications will become possible for those skilled in the art after receiving the teachings of the present disclosure without departing from the scope thereof.

What is claimed is:

1. A stencil printer comprising:
a print drum;
ink feeding means for feeding ink to an inside periphery of said print drum;
ink replenishing means for replenishing ink to said ink feeding means; and
control means for controlling, based on a print condition, replenishment of the ink to said ink feeding means effected by said ink replenishing means.

2. The stencil printer as claimed in claim 1, wherein said control means controls an interval between consecutive replenishments as the replenishment.

3. The stencil printer as claimed in claim 2, wherein said ink feeding means comprises an ink roller for feeding the ink to the inside periphery of said print drum, a doctor member for feeding said ink to an outside periphery of said ink roller and ink sensing means for sensing an amount of the ink present in an ink well formed between said ink roller and said doctor member, and
said control means drives, at an initial stage of printing, said ink replenishing means in accordance with an output of said ink sensing means and causes, when a difference between a reference replenishment interval determined in accordance with the print condition and a sense replenishment interval based on the output of said ink sensing means exceeds a preselected amount, said ink replenishing means to replenish the ink at said reference replenishment interval.

4. The stencil printer as claimed in claim 3, wherein said control means controls, for a preselected period of time, an operation of said ink replenishing means for replenishing the ink at the reference replenishment interval and then operates, if a next sense replenishment interval lies in a preselected variation range, said ink replenishing means in accordance with the output of said ink sensing means.

5. The stencil printer as claimed in claim 1, wherein the print condition comprises at least one of a print speed, a number of prints to be produced, an amount of an image and an environmental temperature.

6. A stencil printer comprising:
a print drum;
an ink roller for feeding ink to an inside periphery of said print drum;
a doctor roller for feeding a preselected amount of ink to an outside periphery of said ink roller;
ink sensing means for sensing an amount of ink present in an ink well formed between said ink roller and said doctor roller;
ink replenishing means for replenishing ink to the ink well in accordance with an output of said ink sensing means; and
control means for controlling, when a sense replenishment interval determined in accordance with the output of said ink sensing means varies by more than a preselected amount inclusive due to repeated printing, said ink replenishing means such that said ink replenishing means replenishes ink at an initial sense replenishment interval.

7. A stencil printer comprising:
a print drum;
an ink feeding device configured to feed ink to an inside periphery of said print drum;
an ink replenishing device configured to replenish ink to said ink feeding device; and
a controller configured to control, based on a print condition, replenishment of the ink to said ink feeding device effected by said ink replenishing device.

8. The stencil printer as claimed in claim 7, wherein said controller controls an interval between consecutive replenishments as the replenishment.

9. The stencil printer as claimed in claim 8, wherein said ink feeding device comprises an ink roller for feeding the ink to the inside periphery of said print drum, a doctor member for feeding said ink to an outside periphery of said ink roller and an ink sensor responsive to an amount of the ink present in an ink well formed between said ink roller and said doctor member, and
said controller drives, at an initial stage of printing, said ink replenishing device in accordance with an output of said ink sensor and causes, when a difference between a reference replenishment interval determined in accordance with the print condition and a sense replenishment interval based on the output of said ink sensor exceeds a preselected amount, said ink replenishing device to replenish the ink at said reference replenishment interval.

10. The stencil printer as claimed in claim 9, wherein said controller controls, for a preselected period of time, an operation of said ink replenishing device for replenishing the ink at the reference replenishment interval and then operates, if a next sense replenishment interval lies in a preselected variation range, said ink replenishing device in accordance with the output of said ink sensor.

11. The stencil printer as claimed in claim 1, wherein the print condition comprises at least one of a print speed, a number of prints to be produced, an amount of an image and an environmental temperature.

12. A stencil printer comprising:
a print drum;
an ink roller for feeding ink to an inside periphery of said print drum;
a doctor roller for feeding a preselected amount of ink to an outside periphery of said ink roller;
an ink sensor configured to sense an amount of ink present in an ink well formed between said ink roller and said doctor roller;
an ink replenishing device configured to replenish ink to the ink well in accordance with an output of said ink sensor; and
a controller configured to control, when a sense replenishment interval determined in accordance with the output of said ink sensor varies by more than a preselected amount inclusive due to repeated printing, said ink replenishing device such that said ink replenishing device replenishes ink at an initial sense replenishment interval.
